(19) United States
(12) Patent Application Publication
(10) Pub. No.: US 2026/0250535 A1
(43) Pub. Date: Aug. 27, 2026

(54) FOOD SAFE AQUEOUS INKJET COMPOSITIONS

(71) Applicant: CANON PRODUCTION PRINTING HOLDING B.V., Venlo (NL)

(72) Inventors: Daniël H. TURKENBURG, Venlo (NL); Jeroen A. SCHELL, Venlo (NL); Guido G. WILLEMS, Venlo (NL); Luc VAN KEULEN, Venlo (NL)

(73) Assignee: CANON PRODUCTION PRINTING HOLDING B.V., Venlo (NL)

(21) Appl. No.: 19/638,389

(22) Filed: Apr. 3, 2026

Related U.S. Application Data
(63) Continuation of application No. PCT/EP2024/077840, filed on Oct. 3, 2024.

(30) Foreign Application Priority Data
Oct. 13, 2023 (EP) 23203487.6

(51) Int. Cl. C09D 11/38

(52) U.S. Cl. CPC C09D 11/38

(57) ABSTRACT

The present invention relates to an aqueous ink-jet composition, such as an ink composition and a pre-treatment composition, comprising a surfactant; and a co-surfactant. The surfactant and the co-surfactant are different and independently selected from the group consisting of C3-C8 primary alcohols, branched (amino) alcohols, alkyl sulfates, alkyl (benzene) sulfonates, C6-C12 alkyl carboxylates and glycol mono ethers. The aqueous ink-jet composition. The invention further relates to the use of such surfactant/co-surfactant combinations in ink-jet compositions suitable to be used in food contact applications and a printing method using such ink-jet compositions.

### CROSS REFERENCE TO RELATED APPLICATIONS

This application is a Continuation of PCT International Application No. PCT/EP2024/077840, filed on Oct. 3, 2024, which claims priority under 35 U.S.C. 119(a) to Patent Application No. 23203487.6, filed in Europe on Oct. 13, 2023, all of which are hereby expressly incorporated by reference into the present application.

### FIELD OF THE INVENTION

The present invention relates to ink-jet imaging materials suitable to be used in food contact applications, e.g. for printing on (food) packaging. In particular the present invention relates to food safe pre-treatment liquids and ink compositions that can be applied onto a recording substrate by means of an ink-jet imaging device. Pre-treatment liquids provide improved interaction of the ink composition and the print substrate to improve image quality and print robustness by pinning colorant particles to the print substrate's surface and by sufficient spreading of the ink composition on the pre-treated surface. The pre-treatment liquid itself should have a good spreading property when applying it by ink-jet printing.

The present invention further relates to an ink-jet printing method comprising applying the pre-treatment liquid of the invention on a recording medium prior to printing an ink-jet image and a method of pre-treating a recording medium, comprising pre-treating a recording medium with a pre-treatment liquid of the invention.

### BACKGROUND ART

For improving image quality in ink-jet printing, pre-treatment liquid compositions have been used to improve the interaction between the recording medium and the inks.

Pre-treatment liquid compositions normally contain salt compositions with acidic and/or electrophilic properties to destabilize pigment color particles. As a result, the behavior of the pigment particles upon drying of the printed medium is optimized. Uncontrollable ink drop coalescence (‘puddling’) and color bleed is prevented, and the optical color density improved.

The pre-treatment liquids comprising a (multivalent) metal salt usually comprise a conjugate base of acids or a halide as an anion.

Pre-treatment liquids, also termed reaction liquids/solutions, primer liquids, (pre-)treatment compositions, processing liquids or ink-receiving solutions, comprising multivalent metal salts are known from the prior art, for example from:

US2008/0092309 pertains to ink-jet printing on fabric and to a pretreatment solution for the fabric that allows high quality printing thereon. The aqueous pretreatment solution/emulsion comprises a nonionic latex polymer and a multivalent cationic salt.

In US2007/0054981, an ink set comprising an ink containing at least an organic pigment, a water-soluble organic solvent and water and a treating liquid which is applied to a recording medium before applying the ink to the recording medium and produces an agglomerate upon contact with the ink, the ink containing a low molecular weight dispersant having a molecular weight of 2000 or lower and polymer fine particles is described.

The pre-treatment composition for ink-jet printing disclosed in US 2012/0314000 comprises: a liquid vehicle, a fixing agent, a non-ionic defoaming surfactant, a surface tension reducing surfactant, and a latex resin having an acid number of less than 20. Published US Patent Application 2012/0019588 discloses fixer fluids, for ink-jet printing comprising a metal carboxylate salt as a fixer agent. In particular calcium acetate, calcium propionate, calcium butyrate, calcium bromide, calcium carbonate, calcium chloride, calcium citrate, calcium cyanamide, calcium phosphate, calcium lactate, calcium nitrate, calcium oxalate and calcium sulfate are disclosed as fixer agents.

Published US Patent Application 2014/0055520 discloses an ink-receiving solution comprising at least one metal salt. In particular calcium chloride.

It is a disadvantage of known pre-treatment liquids and ink compositions that the compositions may contain components that cannot be safely used as food contact materials because of their hazardous properties.

It is another disadvantage of the known pre-treatment liquids that at high salt concentrations, required for enabling application of thin layers to a print substrate to prevent deformation of the print substrate by high liquid loading, the spreading behavior even gets worse, because commonly used surfactants lose their compatibility with the components of the pre-treatment liquids at high salt contents.

It is therefore an object of the present invention to provide pre-treatment liquids comprising a high salt content, which pre-treatment liquids can be safely used in food contact applications and are suitable to be applied in thin layers by ink-jet printing and shows improved spreading behavior.

It is another object of the present invention to provide ink-jet ink compositions that can be used in food contact applications.

### SUMMARY OF THE INVENTION

These objects are at least partially achieved by providing pre-treatment liquids and ink compositions (in combination termed: aqueous ink-jet compositions) according to the present invention.

At least in the context of the present application, Food Contact Materials (FCM) are materials that can be safely used in direct or indirect contact with food, e.g. food packaging.

In a first aspect, the invention relates to an aqueous ink-jet composition comprising:
water;
at least one component selected from the group consisting of a multivalent metal salt, a cosolvent, Ph-regulator, aqueous resin dispersion and a colorant;
a surfactant; and
a co-surfactant,
   wherein the surfactant and the co-surfactant are different and independently selected from the group consisting of C3-C8 primary alcohols, branched (amino) alcohols, alkyl sulfates, alkyl (benzene) sulfonates, C6-C12 alkyl carboxylates and the conjugated C6-C12 alkyl carboxylic acids and glycol mono ethers.

A selected surfactant and co-surfactant in accordance with this first aspect of the present invention are FCM compliant and show a synergistic effect on the solubility of the surfactant and/or the co-surfactant and hence allow the tuning of the surface tension of the aqueous ink-jet composition (e.g. inks and pre-treatment liquids) within a ranges suitable for and ink-jet process (jet stability and balancing spreading and absorption of the aqueous ink-jet composition on a print substrate).

Each surfactant has a spreading- and absorption potential. The addition of cosurfactant induces a synergistic effect which allows for tuning this spreading and absorption potential by tuning surface tension.

In an embodiment, the surfactant is an alkyl benzene sulfonate, preferably a N-dodecyl benzenesulfonate; and the co-surfactant is an alkyl sulfate, preferably selected from the group consisting of N-octyl sulfate, N-decyl sulfate, N-dodecyl sulfate salts, wherein a N-octyl sulfate salt is most preferred. K⁺, Na⁺, Li⁺, Cs⁺ and NH₄⁺ may be suitable counter-ions for the (co-)surfactants, as long as the criteria of the present invention are met. K⁺ and Na⁺ are preferred.

In an embodiment, the surfactant is an alkyl sulfate, preferably selected from the group consisting of N-octyl sulfate, N-decyl sulfate and N-dodecyl sulfate salts; and the co-surfactant is a C3-C8 primary alcohol or a branched alcohol, preferably selected from the group consisting of 1-propanol, 1-butanol, 1-pentanol, 1-hexanol, 1-heptanol, 1-octanol and 2-ethylhexanol.

Most preferred are N-octyl sulfate salts as surfactant and 1-butanol as co-surfactant.

K⁺, Na⁺, Li⁺, Cs⁺ and NH₄⁺ may be suitable counter-ions for the (co-)surfactants, as long as the criteria of the present invention are met. K⁺ and Na⁺ are preferred.

In this embodiment, the combined total amount of surfactant and co-surfactant may be small, e.g. below 5 wt % (relative to the total composition), preferably below 2 wt % and even more preferably below 1 wt %. With the ratio between surfactant and co-surfactant, the surface tension of the aqueous ink-jet composition can be tuned.

In an embodiment, the surfactant is an alkyl sulfate, preferably selected from the group consisting of: N-octyl sulfate, N-decyl sulfate and N-dodecyl sulfate salts; and the co-surfactant is a branched amino alcohol, preferably 2-amino-2-methyl-1-propanol.

K⁺, Na⁺, Li⁺, Cs⁺ and NH₄⁺ may be suitable counter-ions for the (co-)surfactants, as long as the criteria of the present invention are met. K⁺ and Na⁺ are preferred.

Additional advantage of this embodiment is that 2-amino-2-methyl-1-propanol has a relatively high pKa which allows pH tuning of the aqueous ink-jet composition. Therefore, the use of pH-regulators can be reduced or even omitted.

In an embodiment, the surfactant is a C6-C12 alkyl carboxylate, preferably selected from the group consisting of heptanoate, nonoate, decanoate and undecanoate salts; and the co-surfactant is a C3-C8 primary alcohol, preferably selected from the group consisting of 1-propanol, 1-butanol, 1-pentanol, 1-hexanol, 1-heptanol, 1-octanol or the C6-C12 conjugated alkyl carboxylic acid of the surfactant (by adjusting the pH), preferably selected from the group consisting of heptanoic acid, nonoic acid, decanoic acid and undecanoic acid.

K⁺, Na⁺, Li⁺, Cs⁺ and NH₄⁺ may be suitable counter-ions for the (co-)surfactants, as long as the criteria of the present invention are met. K⁺ and Na⁺ are preferred.

K heptanoate shows good surface-active properties in high salinity aqueous compositions such as pre-treatment liquids (primers).

K nonoate, K decanoate and K undecanoate show good surface-active properties in low salinity aqueous compositions such as inks.

In combination with one of the FCM-co-surfactants, even super wetter equivalent properties can be achieved. The same effect can be achieved by adjustment of the pH of the aqueous ink-jet compositions which shifts the alkyl carboxylate and conjugated alkyl carboxylic acid equilibrium. In the context of the present invention, the conjugated alkyl carboxylic acid acts as co-surfactant.

In an embodiment the surfactant is an alkyl sulfate, preferably selected from the group consisting of N-octyl sulfate, N-decyl sulfate and N-dodecyl sulfate salts; and the co-surfactant is a glycol mono ether, preferably selected from the group consisting of ethylene glycol mono butyl ether, diethylene glycol mono butyl ether, dipropylene glycol mono methyl ether, diethylene glycol mono ethyl ether and tripropylene glycol mono butyl ether.

K⁺, Na⁺, Li⁺, Cs⁺ and NH₄⁺ may be suitable counter-ions for the (co-)surfactants, as long as the criteria of the present invention are met. K⁺ and Na⁺ are preferred.

The surface tension of the aqueous ink-jet composition (and hence the absorption/spreading balance) can be tuned by changing the surfactant/co-surfactant ratio. The co-surfactant according to this embodiment are less volatile, so no VOC's (Volatile Organic Components) are added to the aqueous ink-jet composition.

In an embodiment the surfactant is present in an amount of between 0.1 wt % and 5.0 wt %, preferably between 0.1 wt % and 3.0 wt %, more preferably between 0.1 wt % and 1.0 wt % with reference to the total aqueous ink-jet composition.

In an embodiment, the co-surfactant is present in an amount of between 0.1 wt % and 5 wt % preferably between 0.1 wt % and 3.0 wt %, more preferably between 0.1 wt % and 1.0 wt % with reference to the total aqueous ink-jet composition.

In an embodiment, the at least one component is a multivalent metal salt. The aqueous ink-jet composition according to this embodiment is also termed a pre-treatment liquid or primer.

In an embodiment, the at least one component is a colorant. The aqueous ink-jet composition according to this embodiment is an ink composition. If the aqueous ink-jet composition further comprises an aqueous resin dispersion, the ink composition is a latex ink composition.

In a second aspect, the present invention relates to the use of a surfactant and a co-surfactant in ink-jet compositions suitable to be used in food contact applications, wherein the surfactant and the co-surfactant are different and independently selected from the group consisting of C3-C8 primary alcohols, branched (amino) alcohols, alkyl sulfates, alkyl (benzene) sulfonates, C6-C12 alkyl carboxylates, C6-C12 alkyl carboxylic acids and glycol mono ethers.

In a third aspect, the present invention relates to a method of printing comprising the steps of:
a. treating a print substrate by applying an aqueous ink-jet composition according to the first aspect of the present invention onto a surface of the print substrate;
b. subsequently applying an aqueous ink composition comprising an aqueous resin dispersion and/or a colorant onto the treated print substrate obtained in step a.

In principle, the aqueous ink composition may be any aqueous ink composition as long as it comprises at least one component that shows an interaction with the aqueous ink-jet composition according to the first aspect of the present invention that is applied in step a. Examples of such components are aqueous resin dispersions and colorant dispersions, in particular charge stabilized (ionically stabilized) pigment dispersions. The interaction may be a coagulation of dispersed colorant (pigment) particles with the purpose of pinning the pigment particles to the print substrate.

### BRIEF DESCRIPTION OF THE DRAWINGS

The present invention will become more fully understood from the detailed description given herein below and accompanying schematical drawings which are given by way of illustration only and are not limitative of the invention, and wherein:

FIG. 1 shows a schematic representation of an ink-jet printing system.

FIGS. 2A-2C show a schematic representation of an ink-jet marking device: A) and B) assembly of inkjet heads; C) detailed view of a part of the assembly of inkjet heads.

FIG. 3 shows a graph of the surface tension of an exemplified embodiment of an aqueous inkjet composition according to the present invention.

FIG. 4 shows pictures of droplet absorption into a print substrate as a function of time of exemplified embodiments of aqueous inkjet compositions according to the present invention.

### DETAILED DESCRIPTION

Detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually and appropriately detailed structure. In particular, features presented and described in separate dependent claims may be applied in combination and any combination of such claims are herewith disclosed.

Further, the terms and phrases used herein are not intended to be limiting; but rather, to provide an understandable description of the invention. The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language).

In the present specification, amounts of a substance are usually given as mass percent (m %, wt %), unless noted otherwise or clear from the context.

### Recording/Receiving Media (Print Substrates)

Suitable recording media for use in a printing process using an ink or set of inks (e.g. Cyan, Magenta, Yellow and blacK, CMYK) according to the present invention are not particularly limited to any type. The receiving medium may be suitably selected depending on the intended application.

Suitable receiving media may range from strongly water absorbing media such as plain paper (for example Océ Red Label) to non-water-absorbing media such as plastic sheets (for example PE, PP, PVC, and PET films). To optimize print quality, ink-jet coated media are known, which media comprise a highly water absorbing coating.

Of particular interest in the context of the present invention are Machine Coated (MC) media (also known as offset coated media) and glossy (coated) media, particularly MC media. MC media are designed for use in conventional printing processes, for example offset printing and show good absorption characteristics with respect to solvents used in inks used in such printing processes, which are usually organic solvents. MC and glossy media show inferior absorption behavior with respect to water (worse than plain paper, better than plastic sheets), and hence aqueous inks.

The present invention relates to aqueous inkjet compositions that are suitable to be used in food contact applications, e.g. food packaging. Commonly used food packaging materials and hence print substrates are corrugated and solid bleached sulfate papers and boards.

### Aqueous Ink-Jet Composition

An aqueous ink-jet composition as defined in the present application may be any aqueous functional liquid that is applied to a print substrate by means of an ink-jet process, for example a pre-treatment liquid (primer), an ink composition, a maintenance liquid, a varnish, etc.

The present invention basically relates to such aqueous ink-jet compositions, comprising Food Contact Material (FCM) surfactants and co-surfactants. Aqueous ink-jet compositions according to the present invention further comprise water and at least one component selected from the group consisting of a multivalent metal salt, a cosolvent, pH-regulator, aqueous resin dispersion and a colorant. Some of these components are dedicated to being used in a pre-treatment liquid (such as multivalent metal salt) or in an ink composition (such as colorant). Other components may have a more general use in aqueous ink-jet compositions. Below, the more generally used components will be described first, followed by components dedicated for pre-treatment liquids and ink compositions.

### Solvent

Water is cited as an environmentally friendly and hence desirable solvent.

### Cosolvents

To meet jettability requirements, cosolvents may be added to the aqueous ink-jet composition. Cosolvents may have multiple functions, e.g. adapting the rheological behavior (e.g. viscosity) of the aqueous ink-jet composition and/or preventing drying of the aqueous ink-jet composition in the imaging device or on the nozzle surface of the imaging device, which drying may lead to precipitation of solutes present in the aqueous ink-jet composition in the imaging device or on the nozzle surface (nozzle plate).

Cosolvents may also be used to improve penetration of the main solvent (water) into the print substrate, such cosolvents are also termed penetrants.

Cosolvents may also have surface active properties and may be used as (co-)surfactants to tune the surface tension of aqueous ink-jet compositions, including inks and pre-treatment liquids.

The type of cosolvents used is not limited to any kind, as long as the effect of the present invention is preserved.

Examples of suitable cosolvents are water-soluble organic solvents such as polyhydric alcohols, polyhydric alcohol alkyl ethers, polyhydric alcohol aryl ethers, nitrogen-containing heterocyclic compounds, amides, amines, ammonium compounds, sulfur-containing compounds, propylene carbonate, and ethylene carbonate.

Also, more than one cosolvent can be used in combination in the aqueous ink-jet composition according to the present invention. Suitable water-soluble organic solvents listed below.

Examples of water-soluble organic solvents include (but are not limited to): glycerin (also termed glycerol), propylene glycol, dipropylene glycol, tripropylene glycol, tetrapropylene glycol, polypropylene glycol, ethylene glycol, diethylene glycol, triethylene glycol, tetraethylene glycol, polyethylene glycols preferably having a molecular weight of between 200 gram/mol and 1000 gram/mol (e.g. PEG 200, PEG 400, PEG 600, PEG 800, PEG 1000), glycerol ethoxylate, pentaerythritol ethoxylate, polyethylene glycol (di)methylethers preferably having a molecular weight of between 200 gram/mol and 1000 gram/mol, tri-methylol-propane, diglycerol (diglycerin), trimethylglycine (betaine), N-methylmorpholine N-oxide, decaglyserol, 1,4-butanediol, 1,3-butanediol, 1,2,6-hexanetriol, 2-pyrrolidinone, dimethylimidazolidinone, ethylene glycol mono-butyl ether, diethylene glycol monomethyl ether, diethylene glycol monoethyl ether, diethylene glycol mono-propyl ether, diethylene glycol mono-butyl ether, triethylene glycol monomethyl ether, triethylene glycol monoethyl ether, triethylene glycol mono-propyl ether, triethylene glycol mono-butyl ether, tetraethylene glycol monomethyl ether, tetraethylene glycol monoethyl ether, propylene glycol mono-butyl ether, dipropylene glycol monomethyl ether, dipropylene glycol monoethyl ether, dipropylene glycol monopropyl ether, diethylene glycol monobutyl ether, tripropylene glycol monomethyl ether, tripropylene glycol monoethyl ether, tripropylene glycol monopropyl ether, tripropylene glycol monobutyl ether, tetrapropylene glycol monomethyl ether, diethylene glycol diethyl ether, diethylene glycol dibutyl ether, triethylene glycol diethyl ether, triethylene glycol dibutyl ether, dipropylene glycol dibutyl ether, tri propylene glycol dibutyl ether, 3-methyl 2,4-pentanediol, diethylene-glycol-monoethyl ether acetate, 1,2-hexanediol, 1,2-pentanediol and 1,2-butanediol.

In the context of the present invention alkyl glycol mono alkyl ethers such as ethylene glycol mono-butyl ether, diethylene glycol monoethyl ether, diethylene glycol mono-butyl ether, dipropylene glycol monomethyl ether and tripropylene glycol monobutyl ether have been proven to be suitable co-surfactants in certain compositions, which will be further elucidated in the experimental part.

In an embodiment, a mixture of the water-soluble organic solvents may be comprised in an aqueous ink-jet composition according to the present invention. The individual organic solvents preferably being present in an amount of 1 weight % to 40 weight %, more preferably in an amount of 3 weight % to 30 weight %, even more preferably in an amount of 5 weight % to 20 weight %, relative to the total aqueous ink-jet composition.

pH-Regulators

pH-regulators may be added to the aqueous ink-jet composition to optimize the pH of the pre-treatment liquid to meet the pH requirements specified for the used print head. In general, the pH specification of the print head is in the alkaline region (i.e. pH>7). Therefore, alkaline pH-regulators are preferred. Examples of suitable pH-regulators are (but are not limited to): NaOH, KOH, ammonia, (secondary and tertiary) amines, amino alcohols, in particular N-alkyl-dialkanolamines. Specific examples of suitable amino alcohols are: triethanolamine, N-methyldiethanolamine, N-ethyldiethanolamine, N-n-butyl-monoethanolamine and N-n-butyl-diethanolamine.

An example of an acidic pH regulator is acetic acid (Hac).

Examples of food-safe pH-regulators are (but not limited to): acetic acid (Hac), tri-iso-propanol amine, triethanolamine and N,N,N′,N′-tetrakis(2-hydroxypropyl)ethylenediamine (quadrol).

Usually pH-regulators are present in a small amount in the aqueous ink-jet composition, in particular less than 1 wt % with respect to the total pre-treatment liquid composition. However, pH-regulators can be suitably applied in any amount until the desired pH has been reached and as long as the effect of the present invention is preserved.

### Surfactants/Co-Surfactants

Surfactants may be added to an aqueous ink-jet composition to improve the spreading behavior (wettability) of the aqueous ink-jet composition on the print substrate for controlling the image density and color saturation of the formed image and for reducing white spots in the printed image.

Surfactants are not only necessary to control the spreading of the aqueous ink-jet compositions (e.g. ink and pre-treatment liquid) on the print substrate, but also to improve the jetting properties of these compositions. Without surfactants present in these ink-jet imaging materials, the surface tension would be too high to enable proper application by ink-jet printing.

Using surfactants, the surface tension, i.e. the dynamic surface tension as well as the static surface tension, can be adjusted.

To be effective in an aqueous ink-jet composition (e.g. ink and pre-treatment liquid), a surfactant does not only need to reduce the surface tension of the ink-jet imaging material significantly, but it also needs to act very fast, and it needs to be stable and compatible with the other components of the aqueous ink-jet composition.

Examples of suitable surfactants are not limited to any kind, as long as the effect of the present invention is preserved. In practice only a handful of products meets these basic criteria.

For the sake of completeness examples of commonly used surfactants are listed below. The main disadvantage of these surfactants is that most of them do not qualify as Food Contact Material.

Examples of commonly used surfactants include nonionic surfactants, such as acetylene surfactants, cationic surfactants, anionic surfactants, amphoteric surfactants, in particular betaine surfactants.

Examples of a cationic surfactant include aliphatic amine salts, aliphatic quaternary ammonium salts, benzalkonium salts, benzethonium chloride, pyridinium salts, imidazolinium salts.

Examples of an anionic surfactant include: polyoxyethylene alkylether acetic acid salts, dodecylbenzene sulfonic acid salts, lauric acid salts, and salts of polyoxyethylene alkylether sulfate, an aliphatic acid soap, an N-acyl-N-methyl glycin salt, an N-acyl-N-methyl-β-alanine salt, an N-acylglutamate, an acylated peptide, an alkylsulfonic acid salt, an alkylbenzenesulfonic acid salt, an alkylnaphthalenesulfonic acid salt, a dialkylsulfo succinate (e.g. sodium dioctyl sulfosuccinate (DSS); alternative names: docusate sodium, Aerosol OT and AOT), alkylsulfo acetate, α-olefin sulfonate, N-acyl-methyl taurine, a sulfonated oil, a higher alcohol sulfate salt, a secondary higher alcohol sulfate salt, an alkyl ether sulfate, a secondary higher alcohol ethoxysulfate, a polyoxyethylene alkylphenyl ether sulfate, a monoglysulfate, an aliphatic acid alkylolamido sulfate salt, an alkyl ether phosphate salt and an alkyl phosphate salt.

Examples of an amphoteric surfactant include: a carboxybetaine type, a sulfobetaine type, an aminocarboxylate salt and an imidazolium betaine.

Examples of a nonionic surfactant include: polyoxyethylene alkylether, polyoxypropylene polyoxyethylene alkylether, a polyoxyethylene secondary alcohol ether, a polyoxyethylene alkylphenyl ether, a polyoxyethylene sterol ether, a polyoxyethylenelanolin derivative polyoxyethylene polyoxypropylene alkyl ether, polyoxyethylene alkylester, a polyoxyethyleneglycerine aliphatic acid ester, a polyoxyethylene castor oil, a hydrogenated castor oil, a polyoxyethylene sorbitol aliphatic acid ester, a polyethylene glycols aliphatic acid ester, an aliphatic acid monoglyceride, a polyglycerine aliphatic acid ester, a sorbitan aliphatic acid ester, polyoxyethylene sorbitan aliphatic ester, a propylene glycol aliphatic acid ester, a cane sugar aliphatic acid ester, an aliphatic acid alkanol amide, polyoxyethylene alkylamide, a polyoxyethylene aliphatic acid amide, a polyoxyethylene alkylamine, an alkylamine oxide, an alcoxylated alcohol, an acetyleneglycol, an ethoxylated acetylene glycol, acetylene alcohol.

Ethoxylated acetylene glycols have a general structure as shown in Formula.

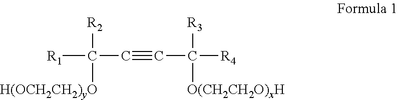

Wherein R₁ and R₄ are the same or different alkyl radicals having from 3-10, preferably from 3-6 carbon atoms, preferably R₁ and R₄ are the same and R₂ and R₃ are the same or different and selected from methyl and ethyl, preferably both R₂ and R₃ are methyl and x and y are both integers and have a sum in the range of between 1 and 60.

Specific examples of ethoxylated acetylene glycols are ethoxylated 3-methyl-1-nonyn-3-ol, ethoxylated 7,10-dimethyl-8-hexadecyne-7,10-diol, ethoxylated 4,7-dimethyl-5-decyne-4,7-diol, ethoxylated 2,4,7,9-tetramethyl-5-decyne-4,7-diol, and ethoxylated 2,5,8,11-tetramethyl-6-dodecyne-5,8-diol. These can be used in combination with each other.

Surfactants may be used separately and in combination of the plural.

Commonly used surfactants as disclosed above may be very effective super wetters, but there may be some important disadvantages. The availability may be limited due to a limited number of production sites in the world. Batch-to-batch variations in composition and purity levels may be large and hence surface-active properties may vary.

Besides these practical aspects there are sustainability issues linked to commonly used surfactants, in particular super wetters. Many surfactants, in particular super wetters have become the subject of debate in view of their (presumed) environmental persistence. Only a few surfactants are listed as approved food contact materials (e.g. Annex 10 of the (Swiss) Ordinance of the FDHA on materials and articles to come into contact with foodstuffs, in short “The Swiss list”).

For the purpose of the present invention, inventors have surprisingly found that certain combinations of surfactants and co-surfactants provide a surfactant system that can be safely used in food contact applications (both the surfactant and the co-surfactant are food contact materials, FCM) and show a synergistic effect on surface active properties. Further, some of the suitable materials serve multiple purposes as will be elucidated further in the experimental section of the present application.

Examples of surfactants and cosurfactants according to the present invention are (but not limited to C3-C8 primary alcohols, branched (amino) alcohols, alkyl sulfates, alkyl (benzene) sulfonates, C6-C12 alkyl carboxylates and the conjugated C6-C12 alkyl carboxylic acids and glycol mono ethers.

Preferably alkyl sulfates, alkyl (benzene) sulfonates or C6-C12 alkyl carboxylates are used as surfactant and C3-C8 primary alcohols, branched (amino) alcohols, alkyl sulfates the conjugated C6-C12 alkyl carboxylic acids and glycol mono ethers are used as co-surfactant.

Without wanting to be bound to any theory, it is believed that cosurfactants position themselves between surfactants at surfaces, allowing for a different placement of the surfactant and thus a different effectivity. Co-surfactants without surfactant are not effective, as they require a surfactant. In general in a surfactant/co-surfactant system, the co-surfactant has the smallest molecular weight.

Therefore, some of the listed components (such as alkyl sulfates) may be used as surfactant (e.g. with a primary alcohol as co-surfactant) and as a co-surfactant (e.g. with an alkyl benzene sulfonate as surfactant).

In principle any combination of surfactant and co-surfactant from those listed above is within the scope of the present invention, as long as the effect of the present invention is preserved.

Suitable examples of primary alcohols are: 1-propanol, 1-butanol, 1-pentanol, 1-hexanol, 1-heptanol and 1-octanol.

Suitable examples of branched (amino) alcohols are: 2-ethylhexanol and 2-amino-2-methyl-1-propanol (AMP-95)

Suitable examples of alkyl sulfates are Na N-octyl sulfate, Na N-decyl sulfate and Na N-dodecyl sulfate.

Suitable examples of alkyl (benzene) sulfonates are Na N-decyl sulfonate and Na N-dodecyl benzenesulfonate.

Suitable examples of C6-C12 alkyl carboxylates and their conjugated C6-C12 alkyl carboxylic acids are Na-heptanoate (heptanoic acid), K-nonoate (nonoic acid), K-decanoate (decanoic acid) and K-undecanoate (undecanoic acid).

Suitable examples of glycol mono ethers are Ethylene glycol mono butyl ether, Diethylene glycol mono butyl ether, Dipropylene glycol mono methyl ether, Diethylene glycol mono ethyl ether, Tripropylene glycol mono butyl ether.

The listed (co-)surfactants satisfy the criteria for Food Contact Materials (Swiss list). As disclosed above, using a combination of a surfactant and co-surfactant selected form the above listed (co-)surfactants provides a synergistic effect on the solubility of both surfactants. Certain combinations provide the ability to tune the balance between spreading on and absorption in the print substrate (see experimental section). 2-amino-2-methyl-1-propanol also acts as pH-regulator.

### (Other) Additives

The aqueous ink-jet composition may optionally further contain additives like biocides and/or a penetrant, which is a compound that promotes absorption of the ink composition in the print medium, and the additives are not particularly limited and comprise those usually used in aqueous ink-jet compositions.

### Pre-Treatment Liquid (Primer)

Pre-treatment liquids according to the present invention comprise a metal salt as an agent for destabilizing charge stabilized dispersed particles in ink compositions such as pigment particles and dispersed polymer particles. Destabilization of dispersed particles may cause coagulation of such particles and hence prevents (excessive) absorption of such particles into the print substrate. Adhesion of e.g. pigment particles to the surface of the print substrate may be promoted by destabilization of the dispersed pigment particles. In general, pre-treatment with pre-treatment liquids may significantly improve image quality and print robustness. Pre-treatment liquids may further comprise additives such as cosolvents, pH-regulators. Pre-treatment liquids according to the present invention can be suitable used on plain papers and machine coated (MC) papers, which are well known in the art.

### Metal Salts

Metal salts that can be suitably used in pre-treatment liquids according to the present invention comprise monovalent metal ions such as Li⁺, Na⁺, K⁺, Hg⁺, Cu⁺, Ag⁺ and Cs⁺. However, it is preferred that thin layers of the pre-treatment liquid can be applied to a print substrate, to prevent deformation of the print substrate (in particular paper-like substrates) due to high liquid loading. Therefore, to provide an effective pre-treatment liquid in thin layers, a salt providing a relatively high ionic strength is preferred.

In the context of the present invention, ionic strength is defined in accordance with equation 1:

$$I = \frac{1}{2} \times {\sum }_{i = 1}^{n} ( {c}_{i} \times {z}_{i}^{2} ) \qquad equation 1$$

wherein:
I is the ionic strength in M (i.e. mol/l);
cᵢ is the concentration of ion i;
zᵢ is the valence of ion i;

For example, the ionic strength of a 0.5 mol/l Na₂SO₄ solution is:

$$0.5 * ( 2 * 0.5 * {( 1 )}^{2} + 1 * 0.5 * {( - 2 )}^{2} ) = 1 \text{.5} M$$

Another criterion to be observed is that the solubility of the selected salt is high enough to be able to prepare an effective pre-treatment solution, e.g. a pre-treatment liquid that can be applied in thin layers (low liquid load) with a high salt content. For these reasons, multivalent metal ions are preferred, such as: Ca²⁺, Mg²⁺, Sr²⁺, Zn²⁺, Cu²⁺, Ni²⁺, Ba²⁺, Fe³⁺, Cr³⁺ and Al³⁺. Of these, Mg²⁺ and Ca²⁺ are most preferred for HSE reasons.

Suitable anions are not particularly limited, if the metal salt is soluble in water and the effects of the present invention are preserved. Examples of anions are halides (e.g. chloride), nitrate, sulfate, sulfamate and conjugated anions of organic acids, for example formate (formic acid), ascorbate (ascorbic acid), glutamate (glutamic acid), pidolate (pidolic acid), taurate (taurine), aspartate (aspartic acid), asparaginate (asparagine), glycinate (glycine), arginate (arginine).

In general, the pre-treatment liquids according to the present invention comprise between 10 wt % and 60 wt %, preferably between 15 w % and 50 wt %, more preferably between 20 wt % and 40 wt % of the multivalent metal salt, with reference to the total composition. The amount of salt is however limited to the maximum solubility of the salt. The saturation degree (actual concentration/maximum solubility*100%) of the salt in the pre-treatment liquid is in general between 10% and 100%, preferably between 15% and 95%, more preferably between 20% and 80%.

### Ink

An ink composition according to the present invention is a water-based ink which is not particularly limited in composition and may comprise an aqueous resin dispersion (also termed latex), a colorant dispersion (e.g. a pigment dispersion), water, a cosolvent, a surfactant and a co-surfactant in accordance with the present invention and optionally other additives. In the ink, the amount of each component is not particularly limited as long as a printing ink is obtained.

### Aqueous Resin Dispersion (Latex)

Examples of the aqueous resin dispersion include synthetic resins and natural polymer compounds. Examples of the synthetic resins include polyester resins, polyurethane resins, polyepoxy resins, polyamide resins, polyether resins, poly(meth)acrylic resins, acryl-silicone resins, fluorine-based resins, polyolefin resins, polystyrene-based resins, polybutadiene-based resins, polyvinyl acetate-based resins, polyvinyl alcohol-based resins, polyvinyl ester-based resins, polyvinyl chloride-based resins, polyacrylic acid-based resins, unsaturated carboxylic acid-based resins and copolymers such as styrene-acrylate copolymer resins, styrene-butadiene copolymer resins. Examples of the natural polymer compounds include celluloses, rosins, and natural rubbers.

Examples of commercially available aqueous resin dispersions (emulsions) include: Joncryl 537 and 7640 (styrene-acrylic resin emulsion, made by Johnson Polymer Co., Ltd.), Microgel E-1002 and E-5002 (styrene-acrylic resin emulsion, made by Nippon Paint Co., Ltd.), Voncoat 4001 (acrylic resin emulsion, made by Dainippon Ink and Chemicals Co., Ltd.), Voncoat 5454 (styrene-acrylic resin emulsion, made by Dainippon Ink and Chemicals Co., Ltd.), SAE-1014 (styrene-acrylic resin emulsion, made by Zeon Japan Co., Ltd.), Jurymer ET-410 (acrylic resin emulsion, made by Nihon Junyaku Co., Ltd.), Aron HD-5 and A-104 (acrylic resin emulsion, made by Toa Gosei Co., Ltd.), Saibinol SK-200 (acrylic resin emulsion, made by Saiden Chemical Industry Co., Ltd.), and Zaikthene L (acrylic resin emulsion, made by Sumitomo Seika Chemicals Co., Ltd.), acrylic copolymer emulsions of DSM Neoresins, e.g. the NeoCryl product line, in particular acrylic styrene copolymer emulsions NeoCryl A-662, NeoCryl A-1131, NeoCryl A-2091, NeoCryl A-550, NeoCryl BT-101, NeoCryl SR-270, NeoCryl XK-52, NeoCryl XK-39, NeoCryl A-1044, NeoCryl A-1049, NeoCryl A-1110, NeoCryl A-1120, NeoCryl A-1127, NeoCryl A-2092, NeoCryl A-2099, NeoCryl A-308, NeoCryl A-45, NeoCryl A-615, NeoCryl BT-24, NeoCryl BT-26, NeoCryl BT-26, NeoCryl XK-15, NeoCryl X-151, NeoCryl XK-232, NeoCryl XK-234, NeoCryl XK-237, NeoCryl XK-238-NeoCryl XK-86, NeoCryl XK-90 and NeoCryl XK-95 However, the aqueous resin dispersion is not limited to these examples.

The resin of the aqueous resin dispersions may be in the form of a homopolymer, a copolymer or a composite resin, and all the resins having a monophase structure or core-shell structure and those prepared by power-feed emulsion polymerization may be used.

### Colorant (Dispersion)

A colorant dispersion may be a pigment or a mixture of pigments, a dye or a mixture of dyes or a mixture comprising pigments and dyes, if the colorant is water dispersed. The pigment is not particularly limited and may be suitably selected in accordance with the intended use.

Examples of the pigment usable include those commonly known without any limitation, and either a water-dispersible pigment or an oil-dispersible pigment is usable. For example, an organic pigment such as an insoluble pigment or a lake pigment, as well as an inorganic pigment such as carbon black, is preferably usable.

Examples of the insoluble pigments are not particularly limited, but preferred are an azo, azomethine, methine, diphenylmethane, triphenylmethane, quinacridone, anthraquinone, perylene, indigo, quinophthalone, isoindolinone, isoindoline, azine, oxazine, thiazine, dioxazine, thiazole, phthalocyanine, or diketopyrrolopyrrole dye.

For example, inorganic pigments and organic pigments for black and color inks are exemplified. These pigments may be used alone or in combination. As the inorganic pigments, it is possible to use carbon blacks produced by a known method such as a contact method, furnace method and thermal method, in addition to titanium oxide, iron oxide, calcium carbonate, barium sulfate, aluminum hydroxide, barium yellow, cadmium red and chrome yellow.

As the organic pigments, it is possible to use azo pigments (including azo lake, insoluble azo pigments, condensed pigments, chelate azo pigments and the like), polycyclic pigments (e.g., phthalocyanine pigments, perylene pigments, perynone pigments, anthraquinone pigments, quinacridone pigments, dioxazine pigments, indigo pigments, thioindigo pigments, isoindolinone pigments, and quinophthalone pigments), dye chelates (e.g., basic dye type chelates, and acidic dye type chelates), nitro pigments, nitroso pigments, aniline black. Among these, particularly, pigments having high affinity with water are preferably used.

Specific pigments which are preferably usable are listed below.

Examples of pigments for magenta or red include: C.I. Pigment Red 1, C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 17, C.I. Pigment Red 22, C.I. Pigment Red 23, C.I. Pigment Red 31, C.I. Pigment Red 38, C.I. Pigment Red 48:1, C.I. Pigment Red 48:2 (Permanent Red 2B(Ca)), C.I. Pigment Red 48:3, C.I. Pigment Red 48:4, C.I. Pigment Red 49:1, C.I. Pigment Red 52:2; C.I. Pigment Red 53:1, C.I. Pigment Red 57:1 (Brilliant Carmine 6B), C.I. Pigment Red 60:1, C.I. Pigment Red 63:1, C.I. Pigment Red 64:1, C.I. Pigment Red 81. C.I. Pigment Red 83, C.I. Pigment Red 88, C.I. Pigment Red 101 (colcothar), C.I. Pigment Red 104, C.I. Pigment Red 106, C.I. Pigment Red 108 (Cadmium Red), C.I. Pigment Red 112, C.I. Pigment Red 114, C.I. Pigment Red 122 (Quinacridone Magenta), C.I. Pigment Red 123, C.I. Pigment Red 139, C.I. Pigment Red 44, C.I. Pigment Red 146, C.I. Pigment Red 149, C.I. Pigment Red 166, C.I. Pigment Red 168, C.I. Pigment Red 170, C.I. Pigment Red 172, C.I. Pigment Red 177, C.I. Pigment Red 178, C.I. Pigment Red 179, C.I. Pigment Red 185, C.I. Pigment Red 190, C.I. Pigment Red 193, C.I. Pigment Red 209, C.I. Pigment Red 219 and C.I. Pigment Red 222, C.I. Pigment Violet 1 (Rhodamine Lake), C.I. Pigment Violet 3, C.I. Pigment Violet 5:1, C.I. Pigment Violet 16, C.I. Pigment Violet 19, C.I. Pigment Violet 23 and C.I. Pigment Violet 38.

Examples of pigments for orange or yellow include: C.I. Pigment Yellow 1, C.I. Pigment Yellow 3, C.I. Pigment Yellow 12, C.I. Pigment Yellow 13, C.I. Pigment Yellow 14, C.I. Pigment Yellow 15, C.I. Pigment Yellow 15:3, C.I. Pigment Yellow 17, C.I. Pigment Yellow 24, C.I. Pigment Yellow 34, C.I. Pigment Yellow 35, C.I. Pigment Yellow 37, C.I. Pigment Yellow 42 (yellow iron oxides), C.I. Pigment Yellow 53, C.I. Pigment Yellow 55, C.I. Pigment Yellow 74, C.I. Pigment Yellow 81, C.I. Pigment Yellow 83, C.I. Pigment Yellow 93, C.I. Pigment Yellow 94, C.I. Pigment Yellow 95, C.I. Pigment Yellow 97, C.I. Pigment Yellow 98, C.I. Pigment Yellow 100, C.I. Pigment Yellow 101, C.I. Pigment Yellow 104, C.I. Pigment Yellow 408, C.I. Pigment Yellow 109, C.I. Pigment Yellow 110, C.I. Pigment Yellow 117, C.I. Pigment Yellow 120, C.I. Pigment Yellow 128, C.I. Pigment Yellow 138, C.I. Pigment Yellow 150, C.I. Pigment Yellow 151, C.I. Pigment Yellow 153 and C.I. Pigment Yellow 183; C.I. Pigment Orange 5, C.I. Pigment Orange 13, C.I. Pigment Orange 16, C.I. Pigment Orange 17, C.I. Pigment Orange 31, C.I. Pigment Orange 34, C.I. Pigment Orange 36, C.I. Pigment Orange 43, and C.I. Pigment Orange 51.

Examples of pigments for green or cyan include: C.I. Pigment Blue 1, C.I. Pigment Blue 2, C.I. Pigment Blue 15, C.I. Pigment Blue 15:1, C.I. Pigment Blue 15:2, C.I. Pigment Blue 15:3 (Phthalocyanine Blue), C.I. Pigment Blue 16, C.I. Pigment Blue 17:1, C.I. Pigment Blue 56, C.I. Pigment Blue 60, C.I. Pigment Blue 63, C.I. Pigment Green 1, C.I. Pigment Green 4, C.I. Pigment Green 7, C.I. Pigment Green 8, C.I. Pigment Green 10, C.I. Pigment Green 17, C.I. Pigment Green 18 and C.I. Pigment Green 36.

In addition to the above pigments, when red, green, blue, or intermediate colors are required, it is preferable that the following pigments are employed individually or in combination thereof. Examples of employable pigments include C.I. Pigment Red 209, 224, 177, and 194, C.I. Pigment Orange 43, C.I. Vat Violet 3, C.I. Pigment Violet 19, 23, and 37, C.I. Pigment Green 36, and 7, C.I. Pigment Blue 15:6.

Further, examples of pigments for black include C.I. Pigment Black 1, C.I. Pigment Black 6, C.I. Pigment Black 7, and C.I. Pigment Black 11. Specific examples of pigments for black color ink usable in the present invention include carbon blacks (e.g., furnace black, lamp black, acetylene black, and channel black); (C.I. Pigment Black 7) or metal-based pigments (e.g., copper, iron (C.I. Pigment Black 11), and titanium oxide; and organic pigments (e.g., aniline black (C.I. Pigment Black 1).

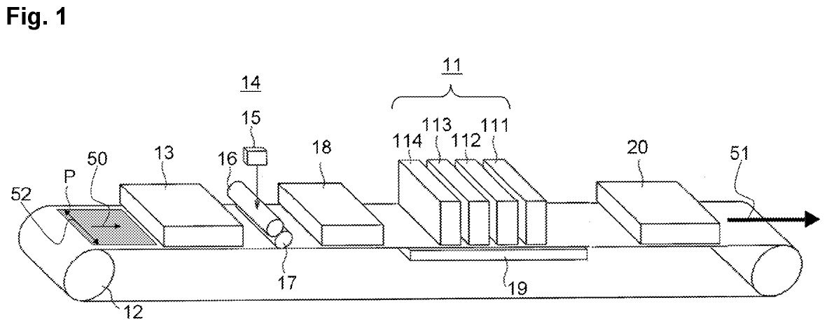

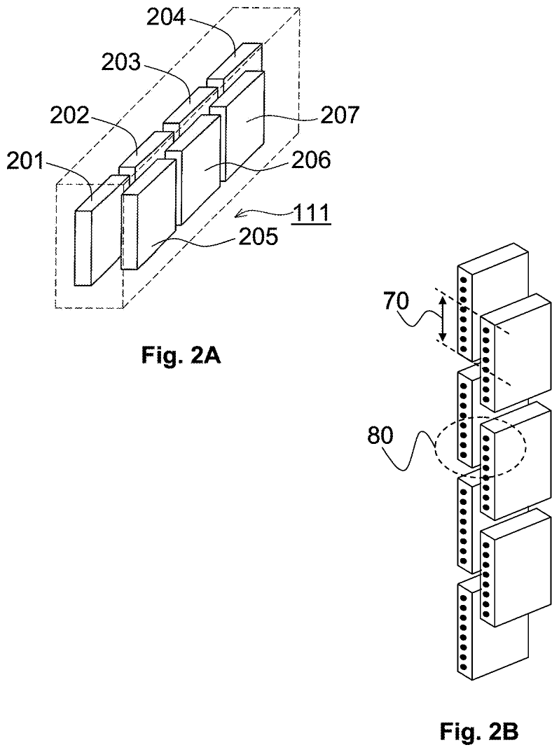

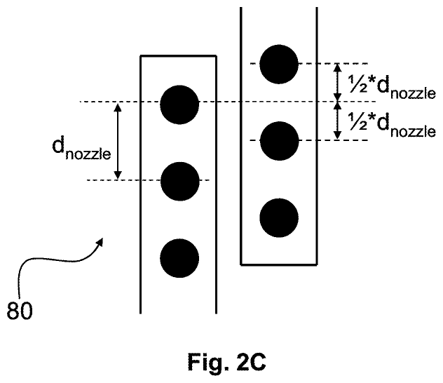

An exemplary printing process in an ink-jet printing apparatus of the present invention will now be described with reference to the appended drawings shown in FIG. 1 and FIG. 2. FIGS. 1 and 2 show schematic representations of an ink-jet printing system and an ink-jet marking device, respectively. However, the present ink-jet printing process and ink-jet printing apparatus are not limited to this exemplary embodiment.

FIG. 1 shows that a sheet of a recording medium, in particular a machine coated medium, P, is transported in a direction for conveyance as indicated by arrows 50 and 51 and with the aid of transportation mechanism 12. Transportation mechanism 12 may be a driven belt system comprising one (as shown in FIG. 1) or more belts. Alternatively, one or more of these belts may be exchanged for one or more drums. A transportation mechanism may be suitably configured depending on the requirements (e.g. sheet registration accuracy) of the sheet transportation in each step of the printing process and may hence comprise one or more driven belts and/or one or more drums. For a proper conveyance of the sheets of receiving medium, the sheets need to be fixed to the transportation mechanism. The way of fixation is not particularly limited and may be selected from electrostatic fixation, mechanical fixation (e.g. clamping) and vacuum fixation.

The printing process as described below comprises the following steps: media pre-treatment, image formation, drying and fixing and optionally post treatment.

### Media Pre-Treatment

To improve the spreading and pinning (e.g. fixation of colorant particles, in particulate pigments and water-dispersed resin (polymer) particles) of the ink on the recording medium, in particular on slow absorbing media, such as machine coated media, the recording medium is pre-treated, i.e. treated prior to printing an image on the medium. The pre-treatment step comprises the application of the pre-treatment liquid of the present invention and may further comprise one or more of the following:
preheating of the receiving medium to enhance spreading of the used ink on the receiving medium and/or to enhance absorption of the used ink into the receiving medium.
corona or plasma treatment.

### Primer Pre-Treatment

As an application way of the pre-treatment liquid, any conventionally known methods can be used. Specific examples of an application way include: a roller coating, an ink-jet application, a curtain coating, and a spray coating.

Although application of the pre-treatment liquid by inkjet printing has become a common technique, exemplified in FIG. 1 is a roller coating (see 14 in FIG. 1) method. This coating method enables application of the pre-treatment liquid homogeneously to a recording medium. The amount of the applied pre-treatment liquid with a roller to a recording medium can be suitably adjusted by controlling: the physical properties of the pre-treatment liquid; and the contact pressure of a roller in a roller coater to the recording medium and the rotational speed of a roller in a roller coater which is used for a coater of the pre-treatment liquid. With application of the pre-treatment liquid by inkjet printing, the required layer thickness of pre-treatment liquid can be controlled more easily.

As an application area of the pre-treatment liquid, it may be possible to apply only to the printed portion, or to the entire surface of both the printed portion and the non-printed portion.

### Corona or Plasma Treatment

Corona or plasma treatment may be used as a pre-treatment step by exposing a sheet of a recording medium to corona discharge or plasma treatment. In particular when used on media like polyethylene (PE) films, polypropylene (PP) films, polyethyleneterephthalate (PET) films and machine coated media, the adhesion and spreading of the ink can be improved by increasing the surface energy of the media. With machine coated media, or more in general media with low surface energy, the absorption of water can be promoted which may induce faster fixation of the image and less puddling on the receiving medium. Surface properties of the receiving medium may be tuned by using different gases or gas mixtures as medium in the corona or plasma treatment. Examples are air, oxygen, nitrogen, carbon dioxide, methane, fluorine gas, argon, neon, and mixtures thereof. Corona treatment in air is most preferred.

FIG. 1 shows that the sheet of receiving medium P may be conveyed to and passed through a first pre-treatment module 13, which module may comprise a preheater, for example a radiation heater, a corona/plasma treatment unit, a gaseous acid treatment unit or a combination of any of the above. Subsequently, a predetermined quantity of the present pre-treatment liquid is applied on the surface of the receiving medium P at pre-treatment liquid applying member 14. Specifically, the pre-treatment liquid is provided from storage tank 15 of the pre-treatment liquid to the pre-treatment liquid applying member 14 composed of double rolls 16 and 17. Each surface of the double rolls may be covered with a porous resin material such as sponge. After providing the pre-treatment liquid to auxiliary roll 16 first, the pre-treatment liquid is transferred to main roll 17, and a predetermined quantity is applied on the surface of the recording medium P. Alternatively, the pre-treatment liquid can also be applied by one or more print heads (not shown). Subsequently, the coated printing paper P on which the pre-treatment liquid was supplied may optionally be heated and dried by drying member 18 which is composed of a drying heater installed at the downstream position of the pre-treatment liquid applying member 14 to decrease the quantity of the water content in the pre-treatment liquid to a predetermined range. In alternative embodiments, the drying step may be omitted. In particular when the pre-treatment liquid is applied with ink-jet printing (i.e. by ink-jet print heads). For such embodiments an additional ink-jet marking device may be implemented in the ink-jet marking module (11) and arranged upstream ink-jet marking device 114 (not shown, to the left of ink-jet marking device 114).

To prevent the transportation mechanism 12 being contaminated with pre-treatment liquid, a cleaning unit (not shown) may be installed and/or the transportation mechanism may be comprised of multiple belts or drums as described above. The latter measure prevents contamination of the upstream parts of the transportation mechanism, in particular of the transportation mechanism in the printing region.

### Image Formation

Image formation is performed in such a manner that, employing an ink-jet printer loaded with ink-jet inks, ink droplets are ejected from the ink-jet heads based on the digital signals onto a print medium.

Although both single pass ink-jet printing and multi pass (i.e. scanning) ink-jet printing may be used for image formation, single pass ink-jet printing is preferably used since it is effective to perform high-speed printing. Single pass ink-jet printing is an ink-jet recording method with which ink droplets are deposited onto the receiving medium to form all pixels of the image by a single passage of a recording medium underneath an ink-jet marking module.

In FIG. 1, 11 represents an ink-jet marking module comprising four ink-jet marking devices, indicated with 111, 112, 113 and 114, each arranged to eject an ink of a different color (e.g. Cyan, Magenta, Yellow and blacK). The nozzle density of each head may be 600 or 1200 npi. In the present invention, “npi” indicates the number of nozzles per inch (2.54 cm).

An ink-jet marking device for use in single pass ink-jet printing, 111, 112, 113, 114, has a length, L, of at least the width of the desired printing range, indicated with double arrow 52, the printing range being perpendicular to the media transport direction, indicated with arrows 50 and 51. The ink-jet marking device may comprise a single printhead having a length of at least the width of said desired printing range. The ink-jet marking device may also be constructed by combining two or more ink-jet heads, such that the combined lengths of the individual ink-jet heads cover the entire width of the printing range. Such a constructed ink-jet marking device is also termed a page wide array (PWA) of printheads. FIG. 2A shows an ink-jet marking device 111 (112, 113, 114 may be identical) comprising 7 individual ink-jet heads (201, 202, 203, 204, 205, 206, 207) which are arranged in two parallel rows, a first row comprising four ink-jet heads (201-204) and a second row comprising three ink-jet heads (205-207) which are arranged in a staggered configuration with respect to the ink-jet heads of the first row. The staggered arrangement provides a page wide array of nozzles which are substantially equidistant in the length direction of the ink-jet marking device. The staggered configuration may also provide a redundancy of nozzles in the area where the ink-jet heads of the first row and the second row overlap, see 70 in FIG. 2B. Staggering may further be used to decrease the nozzle pitch (hence increasing the print resolution) in the length direction of the ink-jet marking device, e.g. by arranging the second row of ink-jet heads such that the positions of the nozzles of the ink-jet heads of the second row are shifted in the length direction of the ink-jet marking device by half the nozzle pitch, the nozzle pitch being the distance between adjacent nozzles in an ink-jet head, d_{nozzle} (see FIG. 2C, which represents a detailed view of 80 in FIG. 2B). The resolution may be further increased by using more rows of ink-jet heads, each of which are arranged such that the positions of the nozzles of each row are shifted in the length direction with respect to the positions of the nozzles of all other rows.

In image formation by ejecting an ink, an ink-jet head (i.e. printhead) employed may be either an on-demand type or a continuous type ink-jet head. As an ink ejection system, there may be usable either the electric-mechanical conversion system (e.g., a single-cavity type, a double-cavity type, a bender type, a piston type, a shear mode type, or a shared wall type), or an electric-thermal conversion system (e.g., a thermal ink-jet type, or a Bubble Jet type (registered trade name)). Among them, it is preferable to use a piezo type ink-jet recording head which has nozzles of a diameter of 30 μm or less in the current image forming method.

FIG. 1 shows that after pre-treatment, the receiving medium P is conveyed to upstream part of the ink-jet marking module 11. Then, image formation is carried out by each color ink ejecting from each ink-jet marking device 111, 112, 113 and 114 arranged so that the whole width of the receiving medium P is covered.

Optionally, the image formation may be carried out while the recording medium is temperature controlled. For this purpose a temperature control device 19 may be arranged to control the temperature of the surface of the transportation mechanism (e.g. belt or drum) underneath the ink-jet marking module 11. The temperature control device 19 may be used to control the surface temperature of the recording medium P, for example in the range of 30° C. to 60° C. The temperature control device 19 may comprise heaters, such as radiation heaters, and a cooling means, for example a cold blast, to control the surface temperature of the receiving medium within said range. Subsequently and while printing, the receiving medium P is conveyed to the downstream part of the ink-jet marking module 11.

### Drying and Fixing

After an image has been formed on the receiving medium, the prints have to be dried and the image has to be fixed onto the receiving medium. Drying comprises the evaporation of solvents, in particular those solvents that have poor absorption characteristics with respect to the selected recording medium.

FIG. 1 schematically shows a drying and fixing unit 20, which may comprise a heater, for example a radiation heater. After an image has been formed, the print is conveyed to and passed through the drying and fixing unit 20. The print is heated such that solvents present in the printed image, to a large extent water, evaporate. The speed of evaporation and hence drying may be enhanced by increasing the air refresh rate in the drying and fixing unit 20. Simultaneously, film formation of the ink occurs, because the prints are heated to a temperature above the minimum film formation temperature (MFT). The residence time of the print in the drying and fixing unit 20 and the temperature at which the drying and fixing unit 20 operates are optimized, such that when the print leaves the drying and fixing unit 20 a dry and robust print has been obtained. As described above, the transportation mechanism 12 in the fixing and drying unit 20 may be separated from the transportation mechanism of the pre-treatment and printing section of the printing apparatus and may comprise a belt or a drum.

### EXAMPLES

### Materials

All chemicals were obtained from Sigma Aldrich, unless stated otherwise. The chemicals were used as received.

(Co)surfactants: Sodium Dodecylbenzene sulfonate, Sodium N-octyl sulfate, 1-butanol, 1-hexanol, 2-amino-2-methyl-1-propanol (AMP-95), K-nonoate, K-decanoate, K-undecanoate, Ethylene glycol mono butyl ether, Diethylene glycol mono butyl ether, Dipropylene glycol mono methyl ether, Diethylene glycol mono ethyl ether, Tripropylene glycol mono butyl ether.

### Methods

### Surface Tension

The surface tension is measured using a Sita bubble pressure tensiometer, model SITA online t60, according to the (maximum) bubble pressure method. The surface tension of the liquids to be tested (e.g. aqueous inkjet compositions according to the present invention) is measured at room temperature (RT), 22° C., unless stated otherwise. The static surface tension is determined at a bubble lifetime of 2 seconds (frequency of 0.5 Hz). The dynamic surface tension at a bubble lifetime 50 ms (frequency of 20 Hz).

pH

The pH was measured with a combined glass electrode.

### Comparative Example A: Preparation of Pre-Treatment Liquid (Primer) without Surfactants

39.4 grams of Magnesium sulfate heptahydrate (MgSO₄·7H₂O) and 5 grams of glycerol were added to 55.6 grams of demineralized water to obtain a pre-treatment liquid comprising 19.2 wt % anhydrous MgSO₄ and 5 wt % glycerol, with respect to the total composition.

### Comparative Examples B, C and D: Preparation of Pre-Treatment Liquids (Primers) with Single Surfactant

Comparative Example A was repeated and Sodium N-Dodecylbenzene sulfonate was added in an amount as indicated in Table 1. The amount of demineralized water was adapted to compensate for the added surfactant, such that the pre-treatment liquids comprised 19.2 wt % anhydrous MgSO₄ and 5 wt % glycerol, with respect to the total composition.

### Comparative Example E and Examples 1-4: Preparation of Pre-Treatment Liquids (Primers) with a Cosurfactant Added to the Composition

Comparative Example B was repeated and Sodium N-octyl sulfate was added in an amount as indicated in Table 1. The amount of demineralized water was adapted to compensate for the added cosurfactant, such that the pre-treatment liquids comprised 19.2 wt % anhydrous MgSO₄, 5 wt % glycerol, and 0.2 wt % Sodium N-Dodecylbenzene Sulfonate with respect to the total composition.

As can be seen in Table 1, Sodium N-Dodecylbenzene Sulfonate as used as a single surfactant does not dissolve (properly) in the pre-treatment liquid composition. When used in combination with Sodium N-octyl sulfate, both the surfactant and the co-surfactant dissolve in the pre-treatment composition and enable controlling the dynamic (50 ms) and static (2.0 s) surface tensions of the pre-treatment liquid.

TABLE 1
pre-treatment liquids according to Comparative
Examples A-E and Examples 1-4

| | | | Surface Tension | Surface Tension |
|---|---|---|---|---|
| (Comp.) | Surfactant | Cosurfactant | 50 ms | 2.0 s |
| Example | [wt %]* | [wt %] ** | [mN/m] | [mN/m] |
| A | 0 | 0 | 83.7 | 73.7 |
| B | 0.2 | 0 | Did not dissolve | Did not dissolve |
| C | 0.31 | 0 | Did not dissolve | Did not dissolve |
| D | 0.5 | 0 | Did not dissolve | Did not dissolve |
| E | 0.2 | 0.12 | Did not dissolve | Did not dissolve |
| 1 | 0.2 | 0.16 | 42.1 | 30.8 |
| 2 | 0.2 | 0.25 | 38.9 | 29.3 |
| 3 | 0.2 | 0.34 | 37.6 | 28.7 |
| 4 | 0.2 | 0.62 | 35.3 | 27.6 |

*Sodium N-Dodecylbenzene Sulfonate;
**Sodium N-octyl sulfate

### Comparative Example F: Preparation of Pre-Treatment Liquids (Primers) with a Surfactant Added to the Composition (No Co-Surfactant)

Comparative Example A was repeated and sodium N-octyl sulfate was added in an amount of 0.75 wt % relative to the total composition. The amount of demineralized water was adapted to compensate for the added surfactant, such that the pre-treatment liquids comprised 19.2 wt % anhydrous MgSO₄ and 5 wt % glycerol, with respect to the total composition.

### Examples 5-9: Preparation of Pre-Treatment Liquids (Primers) with a Surfactant and a Co-Surfactant Added to the Composition

Comparative Example A was repeated and a mixture of sodium N-octyl sulfate and 1-butanol was added in accordance with the amounts indicated in Table 2. The total amount of (co-)surfactant was 0.75 wt % relative to the total composition for all examples 5-9. The mass fraction 1-butanol represents the relative (mass) amount of 1-butanol in the sodium N-octyl sulfate/1-butanol mixture. The amount of demineralized water was adapted to compensate for the added surfactant, such that the pre-treatment liquids comprised 19.2 wt % anhydrous MgSO₄ and 5 wt % glycerol, with respect to the total composition.

TABLE 2
pre-treatment liquids according to Comparative
Example F and Examples 5-9

| | Surfactant | Cosurfactant | Surface | Surface |
|---|---|---|---|---|
| | N-octyl | 1-butanol | Tension | Tension |
| (Comp.) | sulfate | [wt %] | 50 ms | 2.0 s |
| Example | [wt %] | (mass fraction) | [mN/m] | [mN/m] |
| F | 0.75 | 0 (0) | 34.8 | 28.5 |
| 5 | 0.6 | 0.15 (0.2) | 32.5 | 27.2 |
| 6 | 0.30 | 0.30 (0.4) | 30.5 | 26.0 |
| 7 | 0.45 | 0.45 (0.6) | 30.7 | 25.3 |
| 8 | 0.15 | 0.60 (0.8) | 34.4 | 26.4 |
| 9 | 0 | 0.75 (1) | 45.7 | 39.9 |

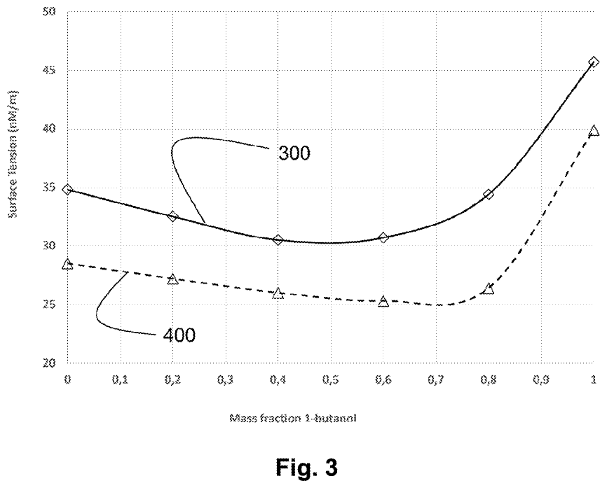

A graph of the surface tension results is shown in FIG. 3. The horizontal (x) axis represents the mass fraction 1-butanol. The vertical (y) axis represents the surface tension. Curve 300 represents the dynamic surface tension (surface tension at 50 ms bubble lifetime). Curve 400 represents the static surface tension (surface tension at 2.0 s). As can be deduced from the results of comparative example F and Examples 5-9, the static and dynamic surface tensions of the pre-treatment liquid can be controlled with a fixed total amount of surfactants and by varying the ratio of surfactant (sodium N-octyl sulfate in the present examples) and co-surfactant (1-butanol in the present examples).

### Comparative Example G and Examples 10-12: Preparation of Pre-Treatment Liquids (Primers) with a Surfactant and a Co-Surfactant Added to the Composition

Comparative Example A was repeated and 0.75 wt % Sodium N-octyl sulfate, 0.78 wt % pH modifier (buffer) and 2-ethyl-1-hexanol was added in an amount as indicated in Table 3. The amount of demineralized water was adapted to compensate for the added components, such that the pre-treatment liquids comprised 19.2 wt % anhydrous MgSO₄ and 5 wt % glycerol, with respect to the total composition.

TABLE 3
Amount of 2-ethyl-1-hexanol (wt %) in pre-treatment
liquids according to examples 10-12

| (Comp.) | 2-ethyl-1-hexanol |
|---|---|
| Example | [wt %] |
| G | 0 |
| 10 | 0.05 |
| 11 | 0.1 |
| 12 | 0.2 |

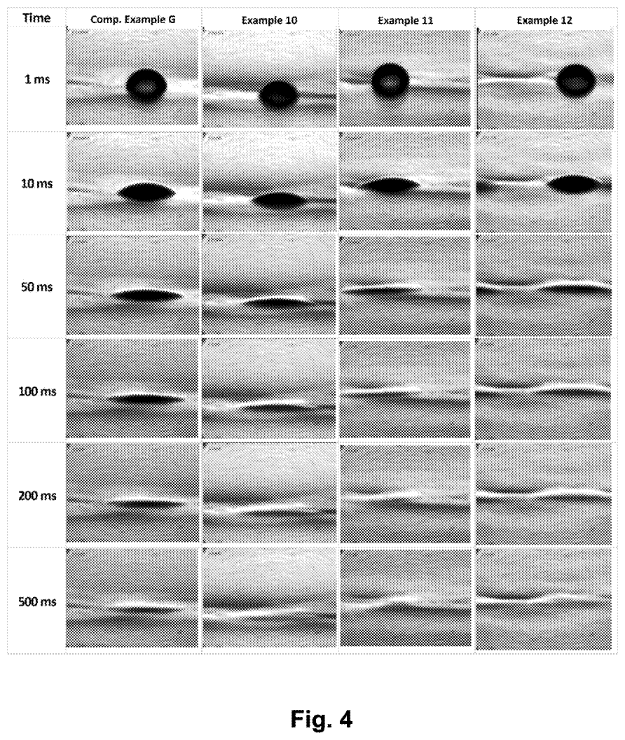

FIG. 4 shows pictures of a droplet of the pre-treatment liquids according to comparative example G and examples 10-12 on print substrate Magno Plus Gloss (115 g/m²) obtained from Sappi as a function of time. The analysis is performed with a set-up comprising a printhead jetting 4-8 picoliter droplet size liquid onto the selected print substrate. The pictures are made with the aid of a microscope and a high-speed camera recording at 15000 frames per second. The addition of 2-ethyl-1-hexanol (a branched alcohol) as a second co-surfactant increases the absorption speed of the pre-treatment liquid.

### Comparative Example H: Preparation of Pre-Treatment Liquid (Primer) with a Surfactant Added to the Composition

Comparative Example A was repeated and sodium N-octyl sulfate was added in an amount of 0.50 wt % relative to the total composition. The amount of demineralized water was adapted to compensate for the added surfactant, such that the pre-treatment liquids comprised 19.2 wt % anhydrous MgSO₄ and 5 wt % glycerol, with respect to the total composition.

### Example 13: Preparation of Pre-Treatment Liquid (Primer) with a Surfactant and a Co-Surfactant Added to the Composition, with (pH) Buffer

Comparative Example H was repeated, and 2-amino-2-methyl-1-propanol (AMP-95) and acetic acid (HAc) were added in amounts as shown in Table 4. The amount of demineralized water was adapted to compensate for the added components, such that the pre-treatment liquids comprised 19.2 wt % anhydrous MgSO₄ and 5 wt % glycerol, with respect to the total composition.

From Table 4 it can be deduced that the addition of AMP-95 reduces the dynamic surface tension (Surface Tension 50 ms) and the AMP-95/HAc has pH buffering capabilities, hence AMP-95 both acts as co-surfactant and as an alkaline buffer component.

TABLE 4
pre-treatment liquids according to Comparative
Example H and Example 13

| | | | | Surface | Surface |
|---|---|---|---|---|---|
| | AMP-95 | Viscosity | | Tension | Tension |
| (Comp.) | [wt %]/ | (@25° C.) | | 50 ms | 2.0 s |
| Example | HAc [wt %] | [mPas] | pH | [mN/m] | [mN/m] |
| H | 0/0 | 4.7 | 7.04 | 35.2 | 27.4 |
| 13 | 0.48/0.3 | 5 | 7.63 | 33.7 | 27.3 |

### Comparative Example I: Pre-Treatment Liquid Comprising a Fatty Acid Surfactant

24.7 grams of Magnesium sulfate heptahydrate (MgSO₄·7H₂O) was dissolved in 62.1 grams of demineralized water, 12.5 grams of glycerol and 0.7 grams of Na-Heptanoate were added to the obtained salt solution. The obtained a pre-treatment liquid comprised 15.7 wt % anhydrous MgSO₄ (equal to 1.3 mol/kg), 12.5 wt % glycerol and 0.7 wt % Na-Heptanoate, with respect to the total composition.

In equilibrium the pre-treatment liquid contains 0.168 wt % heptanoic acid and 0.532 wt % heptanoate anion, which equals a ratio heptanoate anion/heptanoic acid of 3.16. The pH of the prepared pre-treatment liquid was 5.65 which is outside the jettable range (pH should between 7.0 and 8.0).

### Comparative Example J: Pre-Treatment Liquid Comprising Fatty Acid Surfactant with pH Compensation

Comparative Example I was repeated and 1.0 N NaOH solution was added until the pH of the pre-treatment liquid was within the jettable range. At a pH of 7.65, 0.002 wt % of heptanoic acid was present and 0.698 wt % of heptanoate anion, which equals a ratio heptanoate anion/heptanoic acid of 316. This resulted in a high static and dynamic surface tension as shown in Table 5.

### Example 14: Pre-Treatment Liquid Comprising Fatty Acid Surfactant, pH Compensation and Primary Alcohol as Co-Surfactant

Comparative Example J was repeated and 0.20 wt % of n-pentanol was added to the pre-treatment liquid. The amount of demineralized water was adapted to compensate for the added cosurfactant, such that the pre-treatment liquid comprised 15.7 wt % anhydrous MgSO₄ (equal to 1.3 mol/kg), 12.5 wt % glycerol and 0.7 wt % Na-Heptanoate, with respect to the total composition.

The static and dynamic surface tensions returned to acceptable levels as shown in Table 5.

TABLE 5
pre-treatment liquids according to Comparative
Examples I and J and Example

| | | Surface Tension | Surface Tension |
|---|---|---|---|
| (Comp.) | | 50 ms | 2.0 s |
| Example | pH | [mN/m] | [mN/m] |
| I | 5.65 | 30 | 22.7 |
| J | 7.65 | 45 | 39.7 |
| 14 | 7.65 | 28 | 24 |

### Comparative Examples K-M: Ink Compositions Comprising Fatty Acid Surfactant, Fixed pH, No Cosurfactant

Ink compositions were prepared by first mixing water, glycerol and the fatty acid salt in amounts that lead to relative amounts as indicated in Table 6. Subsequently the latex dispersion, the pigment dispersion and finally the 1-hexanol were added. The ink compositions were stirred for 15 minutes and then filtered over a 1.5 μm Pall filter. Ink compositions as disclosed in Table 6 were obtained.

### Examples 15-18: Ink Composition Comprising Fatty Acid Surfactant, Fixed pH, and a Primary Alcohol as Cosurfactant

Ink compositions were prepared in accordance with Comparative Examples K-M and 1-hexanol was added as a co-surfactant in the amounts as indicated in Table 6.

TABLE 6
Ink compositions according to comparative examples K-M and Examples 15-18

| | (Comparative) Example | | | | | | |
|---|---|---|---|---|---|---|---|
| Component [wt %] | K | 15 | L | 16 | M | 17 | 18 |
| K-nonoate | 1.0 | 1.0 | 3.0 | 3.0 | — | — | — |
| K-decanoate | — | — | — | — | 1.5 | 1.5 | 1.5 |
| 1-hexanol | 0 | 0.6 | 0 | 0.6 | 0 | 0.4 | 1 |
| Latex: NeoCryl XK205* | 15 | 15 | 15 | 15 | 15 | 15 | 15 |
| Pigment: Canon O C 2* | 2 | 2 | 2 | 2 | 2 | 2 | 2 |
| Glycerol | 15 | 15 | 15 | 15 | 15 | 15 | 15 |
| water | balance | | | | | | |
| pH | 8.16 | 7.90 | 8.17 | 8.17 | 8.41 | 8.39 | 8.25 |
| Surface Tension 50 ms [mN/m] | 41.0 | 37.0 | 33.0 | 32.0 | 37.0 | 33.7 | 27.2 |
| Surface Tension 2.0 s [mN/m] | 34.0 | 32.5 | 28.4 | 26.4 | 29.7 | 28.2 | 24.2 |

*amount solids w.r.t. total ink composition.

From Table 6 it can be concluded that fatty acid salts can be used as surfactants in inks and that by increasing the fatty acid salt concentration, the surface tensions (static and dynamic) can be steered to acceptable levels (compare Comp K and Comp L). By adding a primary alcohol as cosurfactant, the surface tensions can be further reduced (compare Comp K & Ex. 15; Comp L & Ex. 16; Comp M & Ex. 17&18).

### Comparative Example N: Preparation of Pre-Treatment Liquid Comprising a Surfactant and No Co-Surfactant

39.4 grams of Magnesium sulfate heptahydrate (MgSO₄·7H₂O) was dissolved in 62.1 grams of demineralized water. 0.75 grams sodium octyl sulfate was added. The obtained a pre-treatment liquid comprised 19.2 wt % anhydrous MgSO₄ (equal to 1.6 M MgSO₄) and 0.75 wt % of sodium octyl sulfate, with respect to the total composition.

The pre-treatment composition has a dynamic surface tension (50 ms) of 36.9 mN/m and a static surface tension of 27.8 mN/m.

### Examples 19-29: Preparation of Pre-Treatment Liquid Comprising a Surfactant and Co-Surfactant

Comparative example N was repeated, and an ethylene glycol mono ether as indicated in Table 7 in the amount as indicated in Table 7 was added to the pre-treatment liquid.

TABLE 7
Ink compositions according to comparative example N and Examples 20-30

| | | Amount of | Surface Tension | Surface tension |
|---|---|---|---|---|
| (Comp.) | | co-surfactant | 50 ms | 2.0 s |
| Example | Co-surfactant | [wt %] | [mN/m] | [mN/m] |
| N | — | — | 36.9 | 27.8 |
| 19 | EGBE¹ | 0.1 | 31.4 | 26.4 |
| 20 | EGBE¹ | 0.5 | 28.6 | 24.9 |
| 21 | DEGBE² | 0.1 | 32.2 | 27.0 |
| 22 | DEGBE² | 0.5 | 30.3 | 26.4 |
| 23 | DPGME³ | 0.1 | 34.7 | 27.9 |
| 24 | DPGME³ | 0.5 | 33.7 | 28.3 |
| 25 | DPGME³ | 1.0 | 33.3 | 28.4 |
| 26 | DEGEE⁴ | 0.1 | 36.2 | 27.9 |
| 27 | DEGEE⁴ | 0.5 | 35.3 | 28.4 |
| 28 | DEGEE⁴ | 1.0 | 35.2 | 28.8 |
| 29 | TPGBE⁵ | 0.1 | 29.8 | 25.5 |

¹Ethylene glycol mono butyl ether,
²Diethylene glycol mono butyl ether,
³Dipropylene glycol mono methyl ether,
⁴Diethylene glycol mono ethyl ether,
⁵Tripropylene glycol mono butyl ether

Table 7 shows that ethylene glycol mono ethers are suitable co-surfactants which significantly decrease both the dynamic and static surface tensions of the pre-treatment liquids.

All exemplified combinations of surfactants and co-surfactants comply with the regulations for food contact materials and can therefore be used in pre-treatment liquids and ink compositions that are used in food contact applications.

Therefore, the present invention pertains to:
[1] An aqueous ink-jet composition comprising:
   water;
   at least one component selected from the group consisting of a multivalent metal salt, a cosolvent, pH-regulator, aqueous resin dispersion and a colorant;
   a surfactant; and
   a co-surfactant,
   wherein the surfactant and the co-surfactant are different and independently selected from the group consisting of C3-C8 primary alcohols, branched (amino) alcohols, alkyl sulfates, alkyl (benzene) sulfonates, C6-C12 alkyl carboxylates and the conjugated C6-C12 alkyl carboxylic acids and glycol mono ethers.
[2] Aqueous ink-jet composition according to [1], wherein:
   the surfactant is an alkyl benzene sulfonate; and
   the co-surfactant is an alkyl sulfate.
[3] Aqueous ink-jet composition according to [2], wherein:
   the surfactant is a N-dodecyl benzenesulfonate salt; and
   the co-surfactant is selected from the group consisting of N-octyl sulfate, N-decyl sulfate and N-dodecyl sulfate salts.
[4] Aqueous ink-jet composition according to [1], wherein:
   the surfactant is an alkyl sulfate; and
   the co-surfactant is a C3-C8 primary alcohol or a branched alcohol.
[5] Aqueous ink-jet composition according to [4], wherein:
   the surfactant is selected from the group consisting of a N-octyl sulfate, N-decyl sulfate and N-dodecyl sulfate salts; and
   the co-surfactant is selected from the group consisting of 1-propanol, 1-butanol, 1-pentanol, 1-hexanol, 1-heptanol, 1-octanol and 2-ethylhexanol.
[6] Aqueous ink-jet composition according to [1], wherein:
   the surfactant is an alkyl sulfate or a (benzene) sulfonate; and
   the co-surfactant is a branched amino alcohol.
[7] Aqueous ink-jet composition according to [6], wherein:
   the surfactant is selected from the group consisting of N-octyl sulfate, N-decyl sulfate, N-dodecyl sulfate, and N-dodecyl benzenesulfonate salts; and
   the co-surfactant is selected from the group consisting of 2-amino-2-methyl-1-propanol, 2-(ethylamino)ethanol, 2-(diethylamino)ethanol, butylethanolamine, 2-(methylamino)ethanol and dimethylaminoethanol.
[8] Aqueous ink-jet composition according to [1], wherein:
   the surfactant is a C6-C12 alkyl carboxylate; and
   the co-surfactant is a C3-C8 primary alcohol or the conjugated C6-C12 alkyl carboxylic acid of the surfactant:
[9] Aqueous ink-jet composition according to [8], wherein:
   the surfactant is selected from the group consisting of heptanoate, nonoate, decanoate and undecanoate salts; and
   the co-surfactant is selected from the group consisting of 1-propanol, 1-butanol, 1-pentanol, 1-hexanol, 1-heptanol, 1-octanol or the conjugated alkyl carboxylic acid of the surfactant.
[10] Aqueous ink-jet composition according to [1], wherein:
   the surfactant is an alkyl sulfate; and
   the co-surfactant is a glycol mono ether.
[11] Aqueous ink-jet composition according to [10], wherein:
   the surfactant is selected from the group consisting of N-octyl sulfate, N-decyl sulfate and N-dodecyl sulfate salts; and
   the co-surfactant is selected from the group consisting of ethylene glycol mono butyl ether, diethylene glycol mono butyl ether, dipropylene glycol mono methyl ether, diethylene glycol mono ethyl ether and tripropylene glycol mono butyl ether.
[12] Aqueous ink-jet composition according to any one of [1]-[11], wherein the at least one component is a multivalent metal salt.
[13] Aqueous ink-jet composition according to any of the [1]-[11], wherein the at least one component colorant;
[14] Use of a surfactant and a co-surfactant in ink-jet compositions suitable to be used in food contact applications, wherein the surfactant and the co-surfactant are different and independently selected from the group consisting of C3-C8 primary alcohols, branched (amino) alcohols, alkyl sulfates, alkyl (benzene) sulfonates, C6-C12 alkyl carboxylates and glycol mono ethers.
[15] Method of printing comprising the steps of:
   a. treating a print substrate by applying an aqueous ink-jet composition according to claim 12 onto a surface of the print substrate;
   b. subsequently applying an aqueous ink composition comprising an aqueous resin dispersion and/or a colorant onto the treated print substrate obtained in step a.

1. An aqueous ink-jet composition comprising:
water;
a multivalent metal salt;
a surfactant; and
a co-surfactant,
wherein the surfactant and the co-surfactant are different and independently selected from the group consisting of C3-C8 primary alcohols, branched (amino) alcohols, alkyl sulfates, alkyl (benzene) sulfonates, C6-C12 alkyl carboxylates and the conjugated C6-C12 alkyl carboxylic acids and glycol mono ethers.

2. Aqueous ink-jet composition according to claim 1, wherein
the surfactant is selected from the group consisting of alkyl (benzene) sulfonates, alkyl sulfates, C6-C12 alkyl carboxylates; and
the co-surfactant is selected from the group consisting of alkyl sulfates, C3-C8
primary alcohols, branched (amino) alcohols, the conjugated C6-C12 alkyl carboxylic acids and glycol mono ethers,
wherein the surfactant and the co-surfactant are different.

3. Aqueous ink-jet composition according to claim 1, wherein:
the surfactant is an alkyl benzene sulfonate; and
the co-surfactant is an alkyl sulfate.

4. Aqueous ink-jet composition according to claim 3, wherein:
the surfactant is a N-dodecyl benzenesulfonate salt; and
the co-surfactant is selected from the group consisting of N-octyl sulfate, N-decyl sulfate and N-dodecyl sulfate salts.

5. Aqueous ink-jet composition according to claim 1, wherein:
the surfactant is an alkyl sulfate; and
the co-surfactant is a C3-C8 primary alcohol or a branched alcohol.

6. Aqueous ink-jet composition according to claim 5, wherein:
the surfactant is selected from the group consisting of a N-octyl sulfate, N-decyl sulfate and N-dodecyl sulfate salts; and
the co-surfactant is selected from the group consisting of 1-propanol, 1-butanol, 1-pentanol, 1-hexanol, 1-heptanol, 1-octanol and 2-ethylhexanol.

7. Aqueous ink-jet composition according to claim 1, wherein:
the surfactant is an alkyl sulfate or a (benzene) sulfonate; and
the co-surfactant is a branched amino alcohol.

8. Aqueous ink-jet composition according to claim 7, wherein:
the surfactant is selected from the group consisting of N-octyl sulfate, N-decyl sulfate, N-dodecyl sulfate, and N-dodecyl benzenesulfonate salts; and
the co-surfactant is selected from the group consisting of 2-amino-2-methyl-1-propanol, 2-(ethylamino)ethanol, 2-(diethylamino)ethanol, butylethanolamine, 2-(methylamino)ethanol and dimethylaminoethanol.

9. Aqueous ink-jet composition according to claim 1, wherein:
the surfactant is a C6-C12 alkyl carboxylate; and
the co-surfactant is a C3-C8 primary alcohol or the conjugated C6-C12 alkyl carboxylic acid of the surfactant.

10. Aqueous ink-jet composition according to claim 9, wherein:
the surfactant is selected from the group consisting of heptanoate, nonoate, decanoate and undecanoate salts; and
the co-surfactant is selected from the group consisting of 1-propanol, 1-butanol, 1-pentanol, 1-hexanol, 1-heptanol, 1-octanol or the conjugated alkyl carboxylic acid of the surfactant.

11. Aqueous ink-jet composition according to claim 1, wherein:
the surfactant is an alkyl sulfate; and
the co-surfactant is a glycol mono ether.

12. Aqueous ink-jet composition according to claim 11, wherein:
the surfactant is selected from the group consisting of N-octyl sulfate, N-decyl sulfate and N-dodecyl sulfate salts; and
the co-surfactant is selected from the group consisting of ethylene glycol mono butyl ether, diethylene glycol mono butyl ether, dipropylene glycol mono methyl ether, diethylene glycol mono ethyl ether and tripropylene glycol mono butyl ether.

13. Method of contacting a surfactant and a co-surfactant in an ink-jet composition comprising a multivalent metal salt with food, wherein the surfactant and the co-surfactant are different and independently selected from the group consisting of C3-C8 primary alcohols, branched (amino) alcohols, alkyl sulfates, alkyl (benzene) sulfonates, C6-C12 alkyl carboxylates and glycol mono ethers, the method comprising applying the ink-jet composition onto a print substrate and contacting the print substrate with food.

14. Method according to claim 13, wherein the contacting the print substrate with food is direct.

15. Method according to claim 13, wherein the contacting the print substrate with food is indirect.

16. Method of printing comprising the steps of:
a. treating a print substrate by applying an aqueous ink-jet composition according to claim 1 onto a surface of the print substrate;
b. subsequently applying an aqueous ink composition comprising an aqueous resin dispersion and/or a colorant onto the treated print substrate obtained in step a.
